(19) United States
(12) Patent Application Publication
(10) Pub. No.: US 2015/0208669 A1
(43) Pub. Date: Jul. 30, 2015

(54) Cooking Appliance With Baking Plate Having Embedded Heating Element

(71) Applicant: Spectrum Brands, Inc., Middleton, WI (US)

(72) Inventors: Casey Aaron Klock, Fitchburg, WI (US); Gerald Joseph McNerney, Middleton, WI (US); Kevin Bruce Kinney, Verona, WI (US); Jacob Daniel Smith, Madison, WI (US); Victor Tenorio Chamixaes Cavalcanti, Madison, WI (US); Justin Morgan Vaughner, Madison, WI (US)

(21) Appl. No.: 14/607,788

(22) Filed: Jan. 28, 2015

Related U.S. Application Data
(60) Provisional application No. 61/932,354, filed on Jan. 28, 2014.

(51) Int. Cl. A21B 3/15

(52) U.S. Cl. CPC A21B 3/15

(57) ABSTRACT

In a cooking appliance and method for baking a food product, the appliance has a generally solid plate member, a first heating element disposed above the solid plate member in spaced relationship therewith and a second heating element embedded in the solid plate member.

### CROSS-REFERENCE TO RELATED APPLICATIONS

This application claims the benefit of U.S. Provisional Application No. 61/932,354 filed Jan. 28, 2014, which is incorporated herein in its entirety.

### BACKGROUND

The present invention relates generally to cooking appliances used for baking foods such as crusted foods, and more particularly to a baking plate used in such cooking appliances.

Cooking appliances such as portable or tabletop cooking appliances that are used for baking crusted-type foods, e.g., breads, pizzas, calzones, and the like, are well known. Typically, such cooking appliances include a heat source and a flat stone or ceramic plate—often referred to as a pizza stone—on which the food to be baked is placed and subjected to heating by the heat source. The pizza stone has a high thermal mass to evenly and efficiently distribute heat over the pizza stone, and thus to the food being baked.

One drawback associated with using a pizza stone is that the pizza stone typically requires a long preheat time. Thus, while the heat generated by the heat source of the cooking appliance may be at a desired temperature for baking the food to be baked, the pizza stone may not be. As a result, the top of the food may be baked to a desired finish, while the bottom or crust of the food is undercooked.

There is need, therefore, for a baking plate, e.g., a pizza stone that allows for faster heating or preheating of the pizza stone when used with a cooking appliance for crusted foods.

### SUMMARY

In one embodiment, a cooking appliance generally comprises a generally solid plate member, a first heating element disposed above the solid plate member in spaced relationship therewith, and a second heating element embedded in the solid plate member.

In another embodiment, a method for baking a food product generally comprises supplying current to a first heating element of a cooking appliance to generate heat from the heating element. Current is supplied to a second heating element, with the second heating element being embedded in a solid plate member to initiate heating of the solid plate member. The first heating element is positioned above the solid plate member in spaced relationship therewith. A food product to be baked is placed on the solid plate member.

In another embodiment, a baking plate for heating a food product using a source of current generally comprises a generally solid plate member having an upper baking surface for supporting the food product to be heated, and a circumferential edge margin. An electrically conductive heating element is embedded within the solid plate member. The heating element has at least one terminal accessible from an exterior of the solid plate member for electrical connection with the source of current.

### BRIEF DESCRIPTION

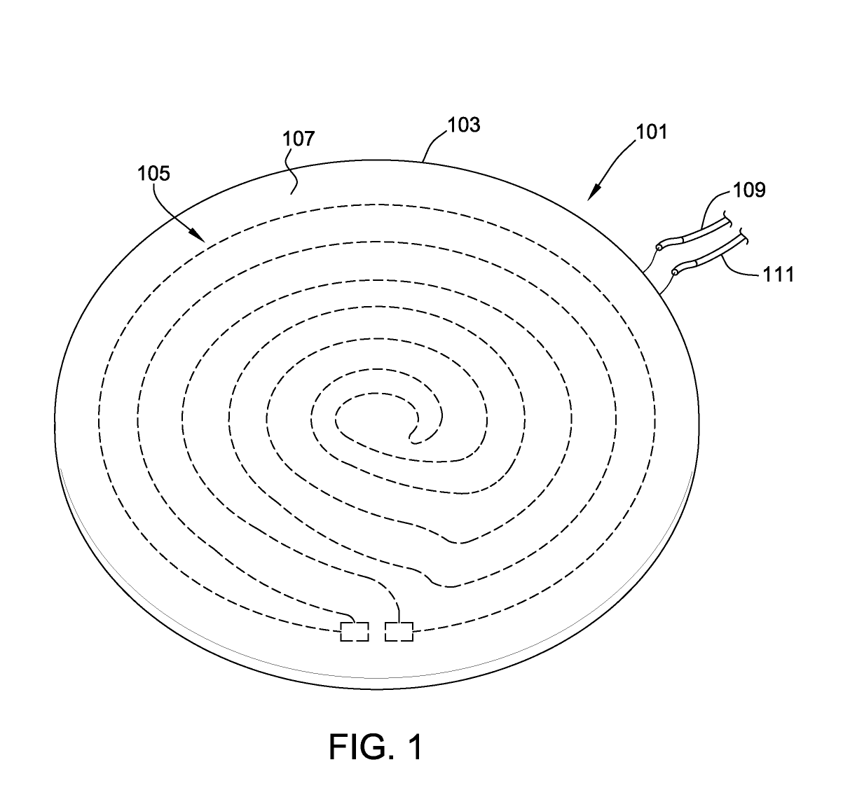

FIG. 1 is a bottom view of a baking plate in accordance with one embodiment of the present disclosure;

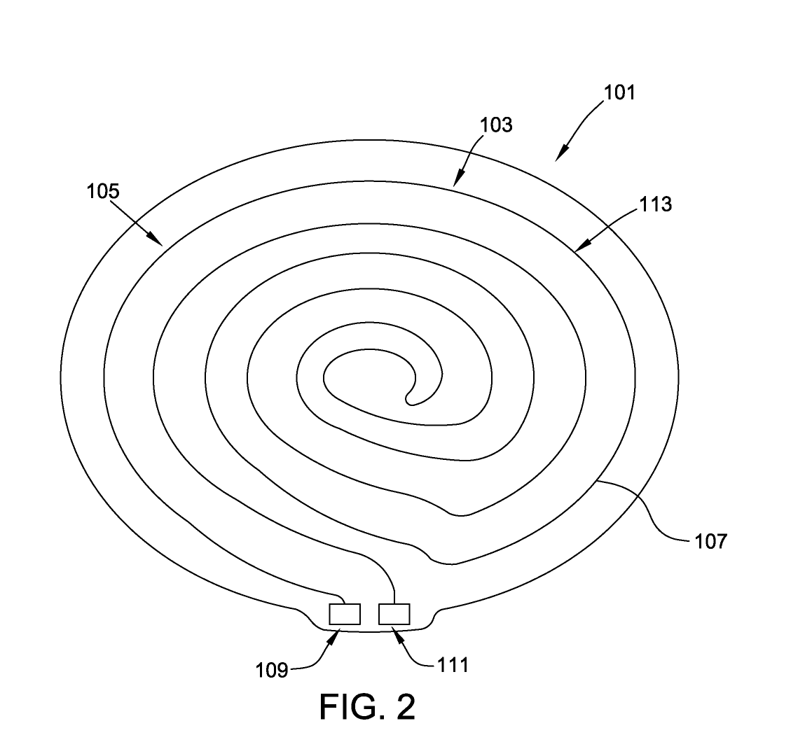

FIG. 2 is a schematic illustration of the baking plate of FIG. 1 showing an embedded heating element;

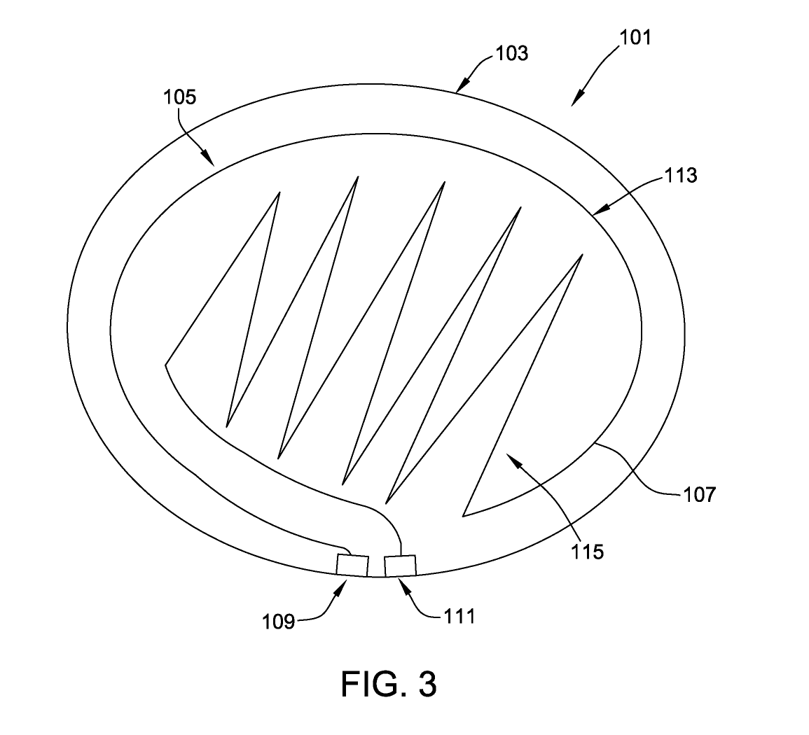

FIG. 3 is a schematic illustration of the baking plate of FIG. 1 showing another embodiment of an embedded heating element;

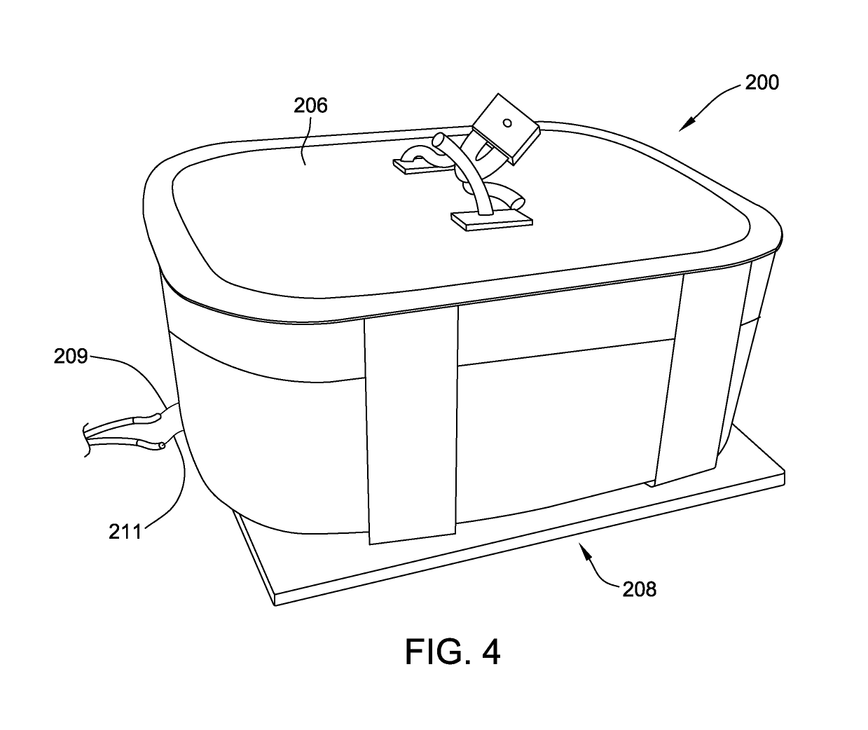

FIG. 4 is a perspective view of a cooking appliance in accordance with one embodiment of the present disclosure;

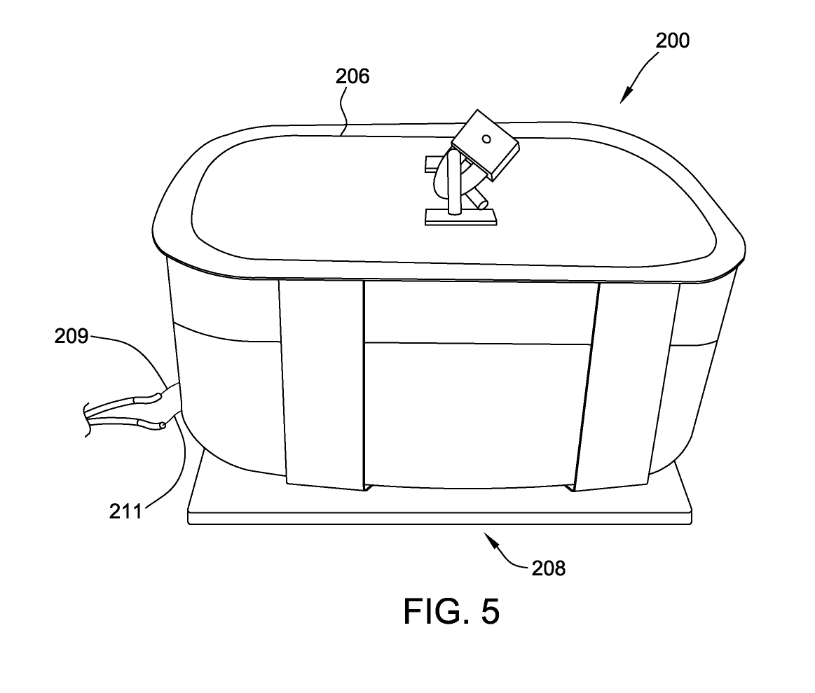

FIG. 5 is a front view thereof;

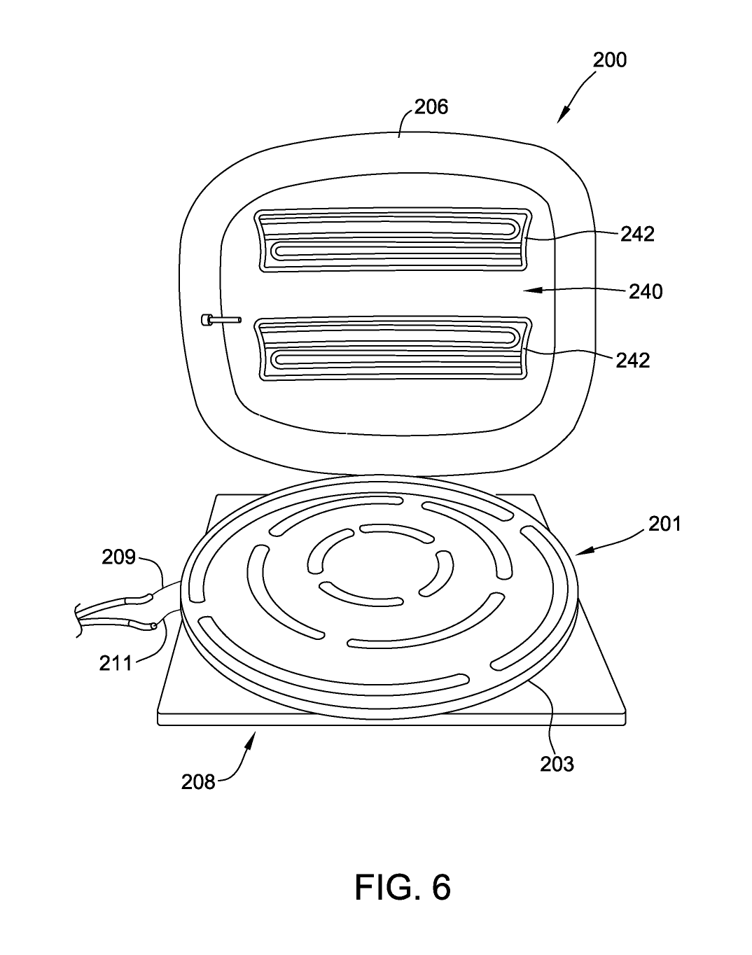

FIG. 6 is a front view of the cooking appliance of FIG. 5 with a housing of the cooking appliance in an opened position;

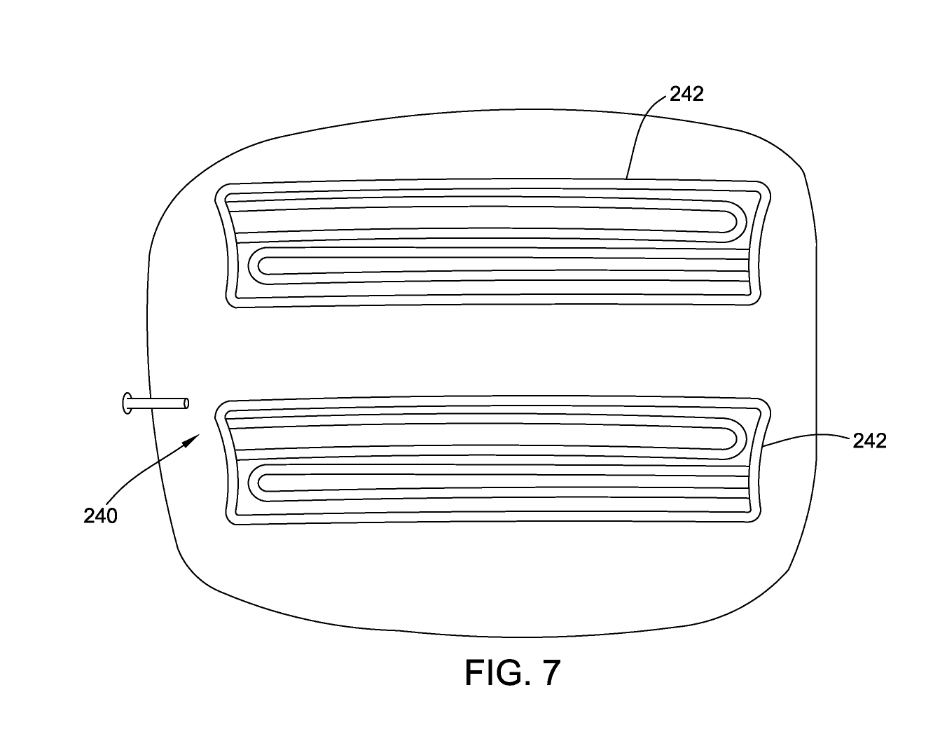

FIG. 7 is a bottom view of a top heating element of the cooking appliance of FIG. 4;

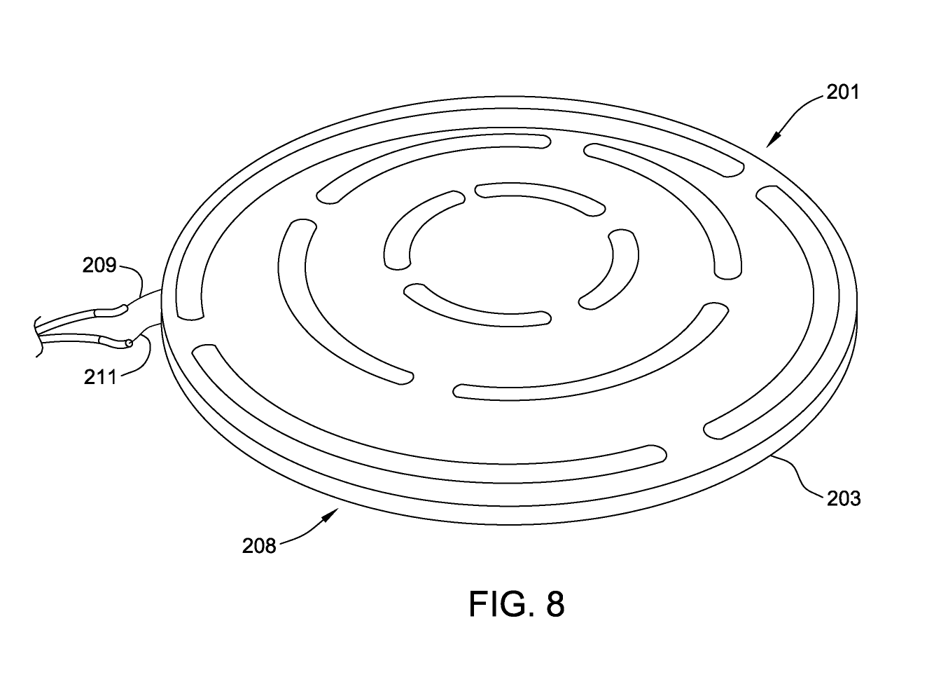

FIG. 8 is a top view of a baking plate of the cooking appliance of FIG. 4;

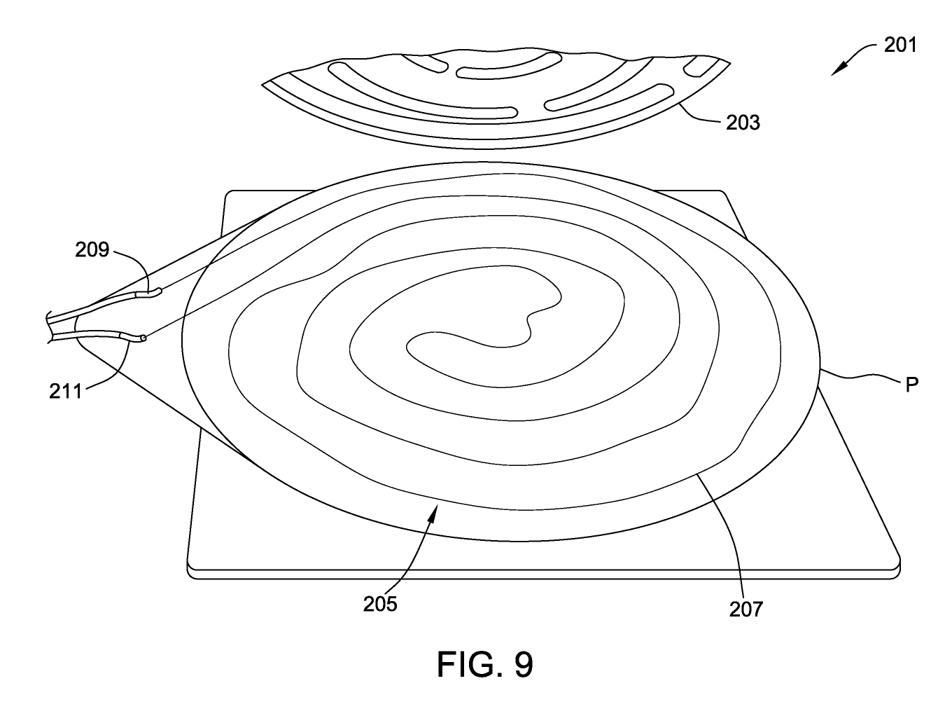

FIG. 9 is a top view of a heating element of the baking plate of FIG. 8;

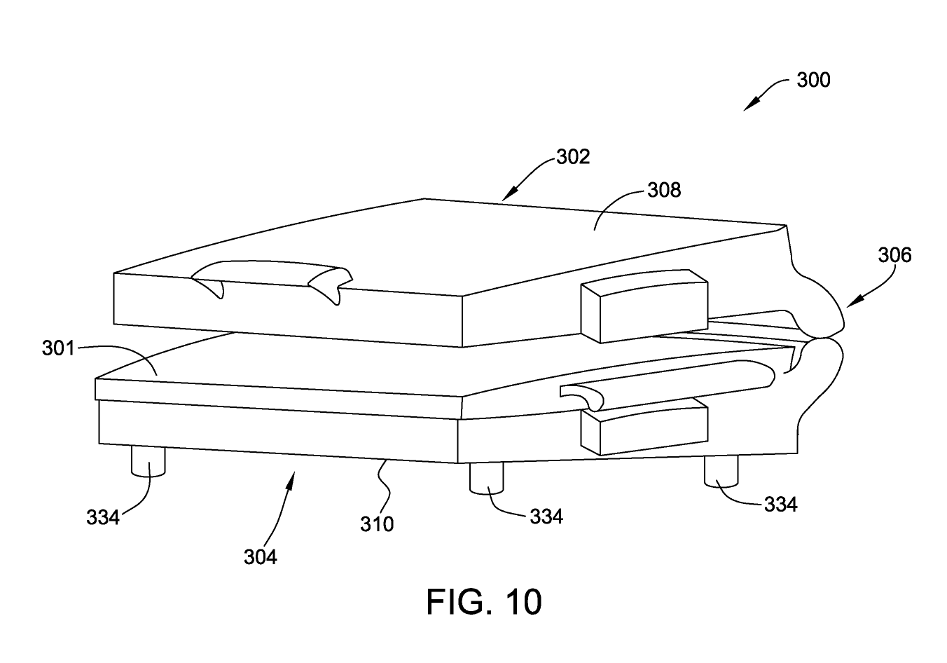

FIG. 10 is a perspective view of another embodiment of a cooking appliance;

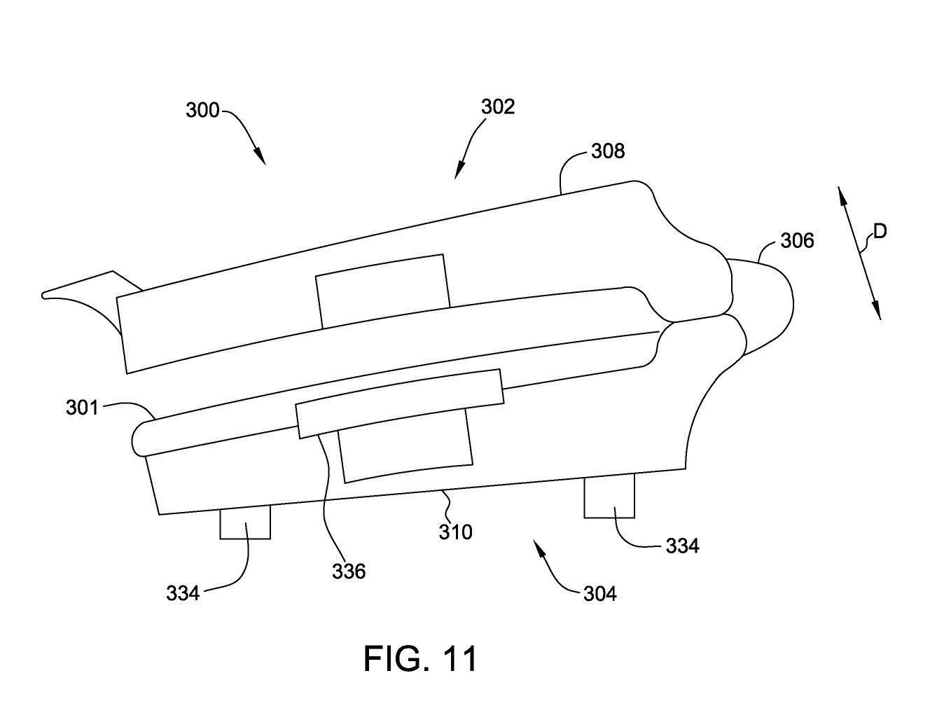

FIG. 11 is a side view of the cooking appliance of FIG. 10;

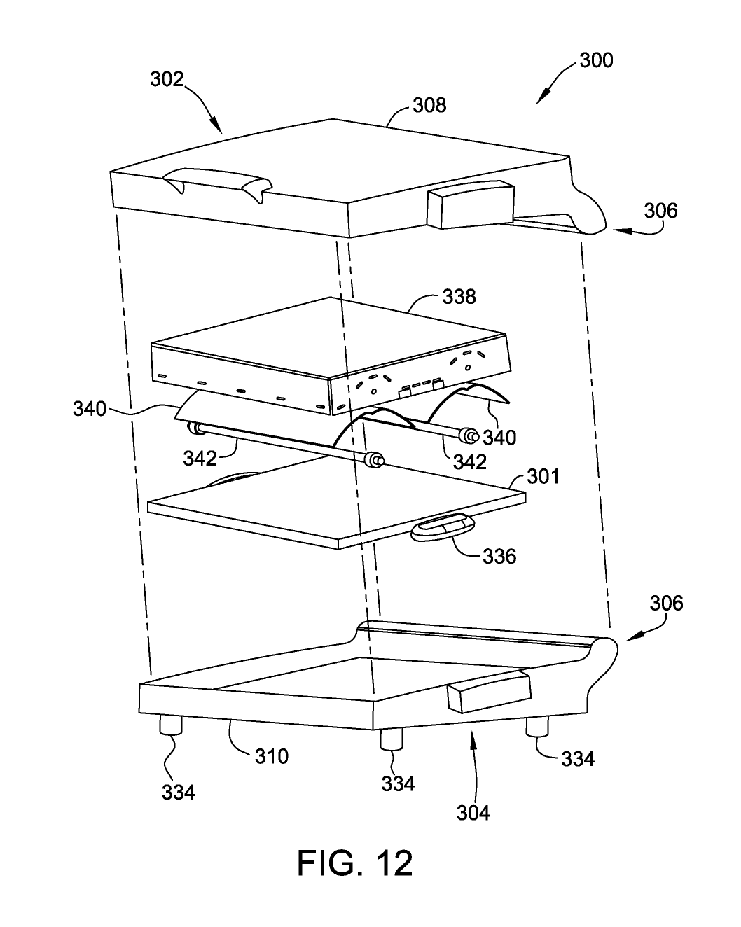

FIG. 12 is an exploded view of the cooking appliance of FIG. 10;

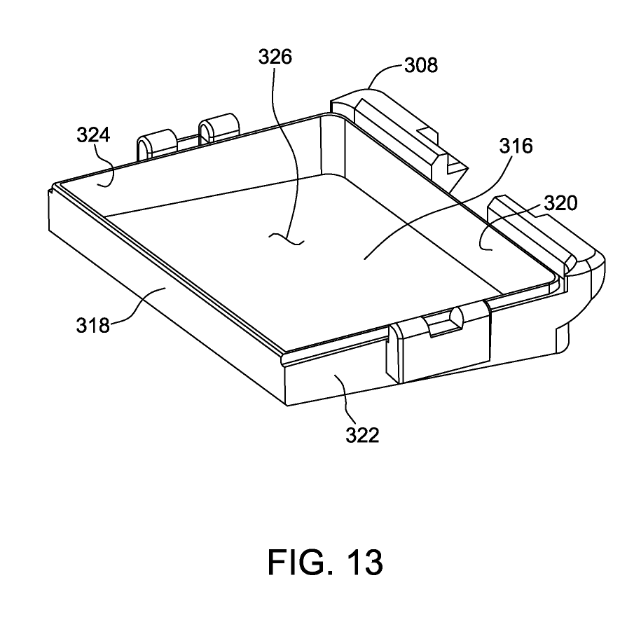

FIG. 13 is a perspective view of an upper housing of the cooking appliance of FIG. 10;

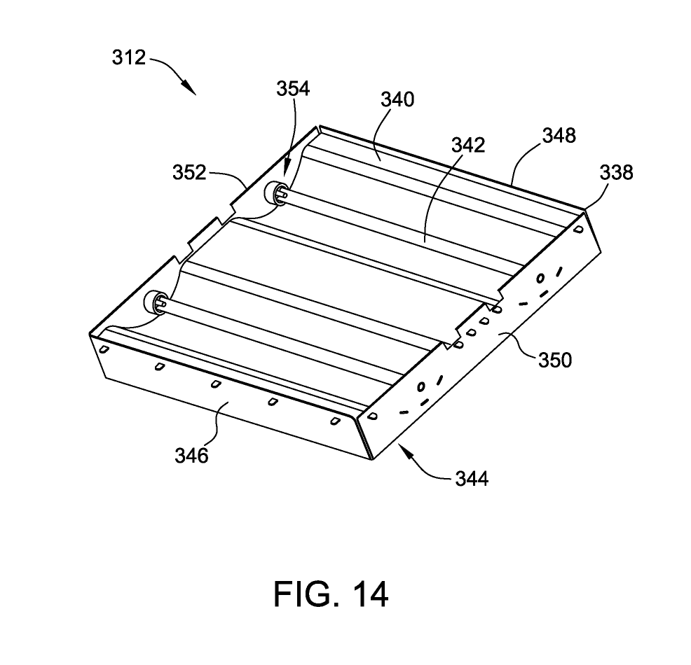

FIG. 14 is a perspective view of a core insert for the upper housing of the cooking appliance of FIG. 10;

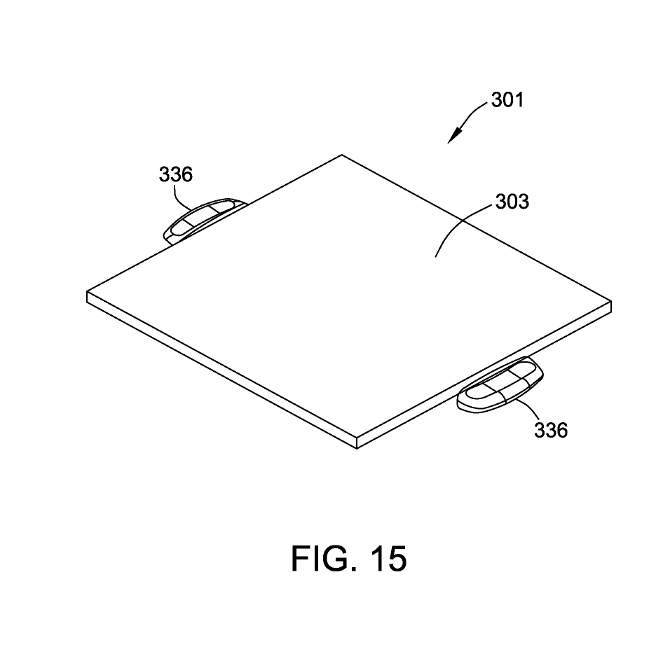

FIG. 15 is a top perspective view of a baking plate of the cooking appliance of FIG. 10;

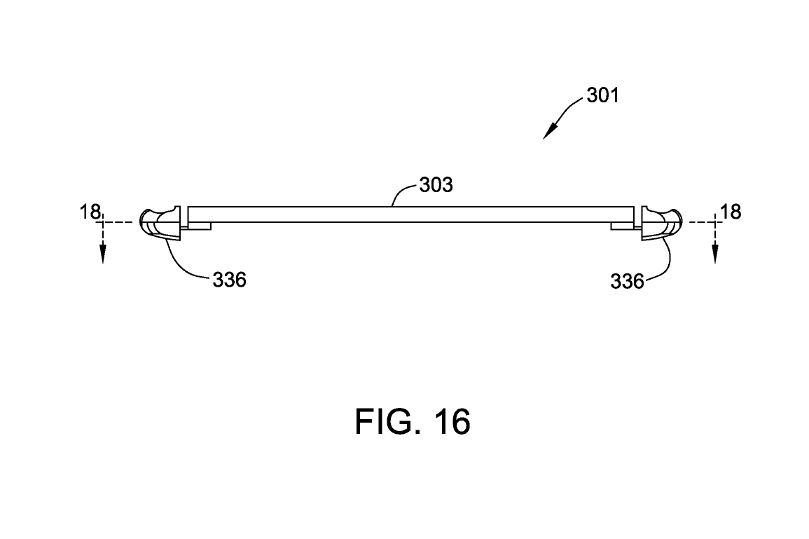

FIG. 16 is a front view of the baking plate of FIG. 15;

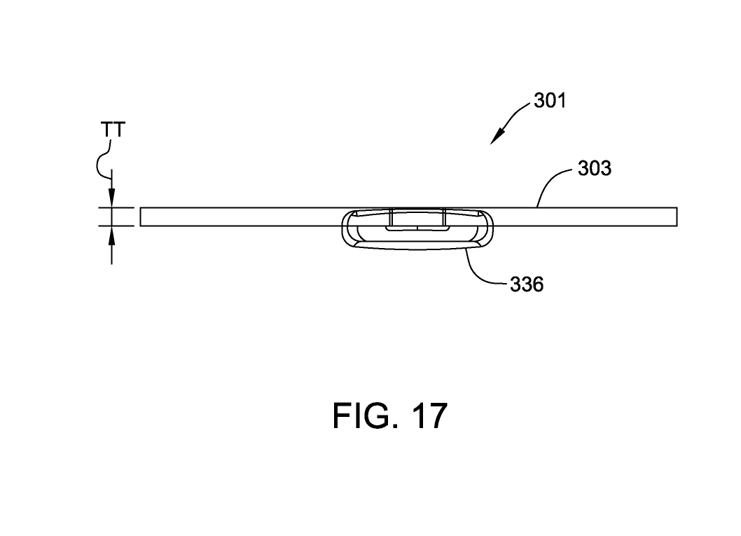

FIG. 17 is a side view of the baking plate of FIG. 15; and

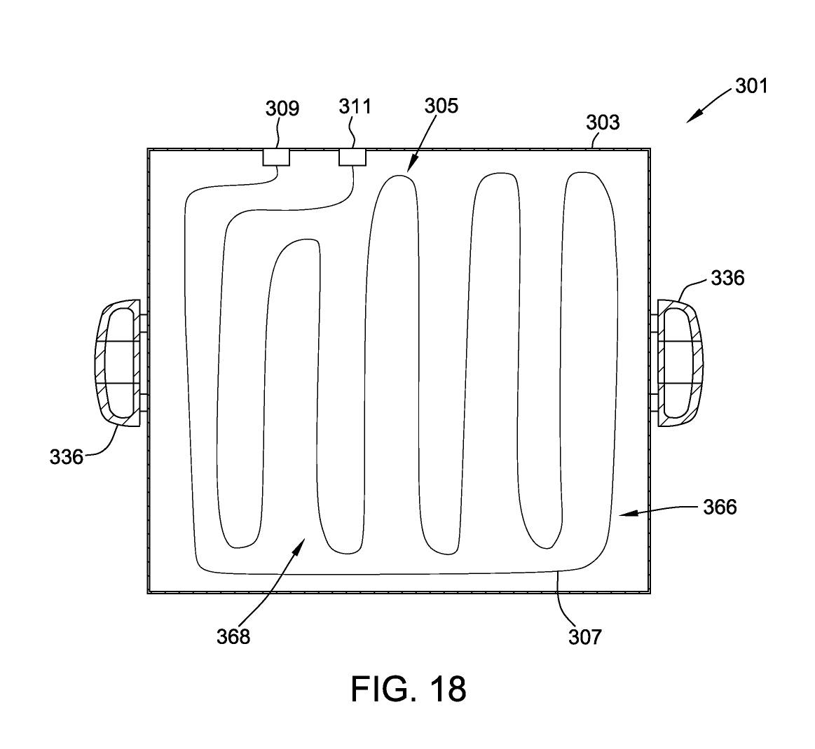

FIG. 18 is a cross-section taken in the plan of line 18-18 of FIG. 16.

Corresponding reference characters indicate corresponding parts throughout the several views of the drawings.

### DETAILED DESCRIPTION

With reference now to the drawings and in particular to FIGS. 1 and 2, a baking plate according to one embodiment of the present disclosure is generally indicated at 101. The baking plate 101, as disclosed herein, is intended for use with a cooking appliance used for baking crusted-type foods such as breads, pizza, calzones, and other foods that are typically baked on a baking tray in a conventional oven. In a particular embodiment, the cooking appliance is a portable or tabletop cooking appliance having a heating source to apply heat to the food to be baked. The baking plate 101 comprises a generally solid plate member 103 and a heating element 105 at least in part embedded within the plate member 103. While one or more segments of the heating element 105 are visible in FIG. 1, it is understood that the heating element may be entirely enclosed within the plate member 103 and otherwise not visible from the exterior of the plate member.

The plate member 103 of the baking plate 101 is suitably constructed of a high insulative material, such as, without limitation, ceramic, clay, stone, glass, concrete, brick, porcelain, or other suitable high insulative material. The illustrated plate member 103 is generally circular, such as in the form that is commonly referred to as a pizza stone. However, it is understood that the plate member 103 may be other than circular without departing from the scope of this disclosure.

The heating element 105, according to one embodiment, is an electrically conductive wire and in one particular embodiment is a nichrome wire that is arranged in a continuous pattern within the plate member 103. For example, FIG. 2 illustrates one embodiment of a pattern formed by a wire 107 that defines the heating element 105. The wire 107 includes a pair of terminals 109, 111 at the edge margin of the plate member 103 for connection with a suitable source of electrical current. The wire 107 is arranged to form a plurality of circular winds 113 spaced radially from each other and from the edge margin of the plate member 103 toward the center thereof. In an alternative embodiment, illustrated in FIG. 3, the wire 107 is arranged to have an outermost circular wind 113 and a zig-zag pattern 115 within the outermost wind. In yet another alternative embodiment, the heating element 105 is a calrod heating element.

It is understood that in other embodiments the wire 107 may be arranged within the plate member 103 in any suitable pattern that covers a substantial area of the plate member. The wire 107 according to one embodiment may have a length (e.g., as measured from one terminal 109 to the other terminal 111) in the range of about 100 inches to about 140 inches. However, the length of the wire 107 may be less than or greater than this range, and may vary depending on the overall size or surface area of the plate member 103. It is also contemplated that more than one wire 107 may be used to define the heating element 105 without departing from the scope of this disclosure.

FIGS. 4-9 illustrate one embodiment of a cooking appliance, generally indicated at 200, for baking crusted-type foods. The cooking appliance 200 is illustrated in a mock-up assembly of representative components including a baking plate 201 constructed in accordance with the present disclosure. In particular, with reference to FIGS. 4-6, the cooking appliance is an oven-type cooking appliance including a base panel 208 and a housing 206 removably positionable relative to the base panel such that the housing and base panel together define an interior space of the cooking appliance. The baking plate 201 is seated on the base panel within the interior space of the cooking appliance when the housing is closed over the base panel. The housing 206 may be hinged to the base panel 208 or may be completely separable from the base panel.

It is understood that the oven-type cooking appliance 200 may be configured other than as illustrated in FIGS. 4-7. For example, the cooking appliance 200 may be configured as a front-loading oven (e.g., in the manner of what is typically referred to as a toaster-oven), or with a base unit supporting the base panel elevated above the surface (e.g., counter-top) on which the appliance sits, or other suitable configuration.

As illustrated in FIGS. 6 and 7, an upper heating system 240 includes a pair of heating elements 242 held by the housing 206 for disposition above the baking plate 201. While not shown in the drawings, one or more reflectors may be mounted on the housing 206 for reflecting heat from the heating elements 242 downward within the interior space toward the baking plate 201.

The baking plate 201, with particular reference to FIGS. 6, 8 and 9, is substantially the same as the baking plate 101 of FIG. 1 in that it comprises a generally circular solid plate member 203 and a heating element 205. For illustrative purposes, the heating element 205 is shown as being arranged on a pad P that is placed beneath the plate member. However, in practice, the heating element is embedded in the plate member as illustrated in FIG. 1. The heating element of this embodiment is a wire 207 arranged in the pattern illustrated in FIG. 2. It is understood, however, that the wire 207 may be arranged in the pattern illustrated in FIG. 3 or in any other suitable pattern. It is also understood that more than one wire 207 may be used to define the embedded heating element without departing from the scope of this invention. The heating element 205 is electrically connected at its terminals 209, 211 to a source of electrical current—which in one embodiment is the same source of electrical current to which the upper heating system 240 is electrically connected.

In operation, before food is placed in the cooking appliance 200, the appliance is turned on to supply current to the upper heating system 240 as well as to the heating element 205 of the baking plate 201. In this manner, the plate member 203 of the baking plate 201 is brought up to a desired temperature more rapidly along with the air temperature (e.g., due to the upper heating system 240) in the interior space of the appliance. The food to be baked is then placed on the upper surface of the baking plate. In one embodiment, the heating element 205 of the baking plate 201 may be controlled to reduce or terminate heating of the plate member 203 after a predetermined time period, or after a threshold temperature of the interior space and/or the plate member is reached. In other embodiments, the heating element 205 may be maintained at constant heating for the entire cooking period of the food to be baked.

FIGS. 10-18 schematically illustrate another embodiment of a cooking appliance, generally indicated at 300, for baking crusted-type foods. In particular, the cooking appliance 300 of this embodiment is an open broiler-type cooking appliance including a baking plate 301 constructed in accordance with the present disclosure. As illustrated in FIGS. 10 and 11, the cooking appliance 300 of this embodiment comprises a top unit (indicated generally by 302) and a bottom unit (indicated generally by 304) that are connected together via a hinge 306. The top unit 302, with reference to FIGS. 12-14 includes a housing 308 and a core insert (indicated generally by 312 in FIG. 14) disposed within the housing 308. As illustrated in FIG. 13, the housing 318 includes a top wall 316, a first end wall 318, a second end wall 320, a first side wall 322, and a second side wall 324 that together define an interior space 326 sized to receive the core insert 312 (FIG. 14).

The core insert 312 is suitably configured for attachment to the top housing 308 within the interior space 326. The core insert 312 includes a frame 338, a reflector 340, and at least one top heating element 342. The frame 338 has a top wall 344, a first end wall 346, a second end wall 348, a first side wall 350, and a second side wall 352 that define a cavity 354 in which the reflector 340 and the top heating element(s) 342 are disposed. The walls 346, 348, 350, and 352 have a receiving mechanism for receiving and retaining the reflector 340 and the top heating element(s) 342 therein. Notably, in other embodiments, the top unit 302 may not include the frame 338 but, rather, the top housing 308 may perform the function of supporting the reflector 340 and/or the top heating element(s) 342 in the manner set forth herein. The illustrated top heating elements 342 are suitably quartz-type heating elements formed as a substantially linearly extending tube. However, it is understood that the top heating elements 342 may be any known heating elements other than quartz-type heating elements and remain within the scope of this disclosure.

Referring back to FIGS. 10-12 the bottom unit 304 includes a bottom housing 310 and the baking plate 301 supported by the bottom housing. The bottom housing 310 may have at least one leg (or stand) 334 configured such that, when the appliance 300 is seated on a surface such as a counter-top, the baking plate 301 is oriented generally level or otherwise parallel to the counter-top. As illustrated in FIGS. 12 and 15-18, the baking plate 301 has a pair of handles 336 connected thereto, and the handles 336 are configured to interface with the bottom housing 310 to facilitate detachable connection (e.g., magnetic connection) of the baking plate with the bottom housing. This allows the baking plate 301 to be removable from the bottom housing 310 for cleaning or replacement.

As in the previous embodiments, the baking plate 301 includes a plate member 303 and a heating element 305 (FIG. 18) at least in part embedded in the plate member. In this embodiment, the plate member 303 is generally rectangular in shape but is otherwise constructed in any manner described above in connection with baking plate 301 of FIGS. 10-12. The heating element 305 is suitably a wire 307 of similar construction to the wire 107 of the baking plate 101 of FIGS. 1-3. As illustrated in FIG. 18, the wire 307 is arranged with an outer circumferential wind 366 and a serpentine pattern 368 within the outer circumferential wind. The wire 307 is electrically connected at terminals 309, 311 to a suitable source of current such as the same current source to which the top heating elements 342 are electrically connected.

With reference back to FIGS. 11 and 12, the hinge 306 enables the top unit 302 to be pivoted relative to the bottom unit 304 between a raised position for loading food to be baked onto the baking plate 301 and a lowered position for baking the food on the baking plate. The hinge 306 is suitably configured to allow the top unit 302 to be adjustably positioned relative to the bottom unit 304 along a direction D to a desired height above the baking plate 301 to accommodate foods of different thicknesses to be baked on the baking plate.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A cooking appliance comprising:
a generally solid plate member;
a first heating element disposed above the solid plate member in spaced relationship therewith; and
a second heating element embedded in the solid plate member.

2. The cooking appliance of claim 1 wherein the solid plate member is constructed of at least one of: ceramic, clay, and stone.

3. The cooking appliance of claim 1 wherein the solid plate member is constructed of at least one of: glass, concrete, brick, and porcelain.

4. The cooking appliance of claim 1 wherein the second heating element comprises an electrically conductive wire embedded in the solid plate member, the wire having at least one terminal accessible from an exterior of the solid plate member.

5. The cooking appliance of claim 4 wherein the wire comprises a nichrome wire.

6. The cooking appliance of claim 4 wherein the solid plate member has a circumferential edge margin and a center, the wire being arranged in the solid plate member in a pattern of circumferential winds each spaced transversely from the edge margin of the plate member toward the center thereof.

7. The cooking appliance of claim 4 wherein the solid plate member has a circumferential edge margin and a center, at least a segment of the wire being arranged in the solid plate member in one of a zig-zag and a pattern.

8. The cooking appliance of claim 1 wherein the cooking appliance further comprises a bottom housing, the solid plate member being supported by the bottom housing, and a top housing, the first heating element being supported by the top housing.

9. The cooking appliance of claim 8 wherein the top housing is configurable between a raised position and a lowered cooking position, the first heating element being spaced from the solid plate member in the lowered cooking position of the top housing.

10. The cooking appliance of claim 9 wherein the top housing is adjustably positionable relative to the bottom housing to adjust a spacing between the first heating element and the solid plate member in the lowered cooking position of the top housing.

11. The cooking appliance of claim 8 wherein the solid plate member is removably supported by the bottom housing.

12. The cooking appliance of claim 1 wherein the appliance comprises a housing, the solid plate member being enclosable within the housing, the first heating element being supported by the housing above the solid plate member.

13. The cooking appliance of claim 1 wherein the second heating element comprises a calrod heating element.

14. A method for baking a food product, the method comprising:
supplying current to a first heating element of a cooking appliance to generate heat from the heating element;
supplying current to a second heating element, the second heating element being embedded in a solid plate member to initiate heating of the solid plate member, the first heating element being positioned above the solid plate member in spaced relationship therewith; and
placing a food product to be baked on the solid plate member.

15. The method of claim 14 further comprising adjusting a height of the first heating element above the solid plate member at least in part as a function of the size of the food to be baked by the cooking appliance.

16. The method of claim 14 further comprising encasing the solid plate member within a housing of the cooking appliance.

17. The method claim 14 further comprising one of reducing or terminating operation of the second heating element independent of operation of the first heating element.

18. The method of claim 17 wherein operation of the second heating element is one of reduced or terminated based at least in part on at least one of: a predetermined operating period of the second heating element, a predetermined temperature threshold of the solid plate member, and a predetermined temperature threshold of the cooking appliance.

19. A baking plate for heating a food product using a source of current, the baking plate comprising:
a generally solid plate member having an upper baking surface for supporting the food product to be heated, and a circumferential edge margin; and
an electrically conductive heating element embedded within the solid plate member, the heating element having at least one terminal accessible from exterior of the solid plate member for electrical connection with the source of current.

20. The baking plate of claim 19 wherein the solid plate member is constructed of at least one of: ceramic, clay, and stone.

21. The baking plate of claim 19 wherein the solid plate member is constructed of at least one of: glass, concrete, brick, and porcelain.

22. The baking plate of claim 19 wherein the heating element comprises an electrically conductive wire embedded in the solid plate member, the wire having at least one terminal accessible from exterior of the solid plate member.

23. The baking plate of claim 22 wherein the wire comprises a nichrome wire.

24. The baking plate of claim 22 wherein the solid plate member has a center, the wire being arranged in the solid plate member in a pattern of circumferential winds each spaced transversely from the edge margin of the plate member toward the center thereof.

25. The baking plate of claim 22 wherein at least a segment of the wire is arranged in the solid plate member in one of a zig-zag and a pattern.

26. The baking plate of claim 19 wherein the baking plate is a pizza stone.
